(19) United States
(12) Patent Application Publication
(10) Pub. No.: US 2004/0159535 A1
(43) Pub. Date: Aug. 19, 2004

(54) Hermetic sealed switch

(76) Inventor: Josef Wagner, Lachen (CH)

Correspondence Address: PEARNE & GORDON LLP, 1801 EAST 9TH STREET, SUITE 1200, CLEVELAND, OH, 44114-3108, US

(21) Appl. No.: 10/367,065

(22) Filed: Feb. 14, 2003

(51) Int. Cl. H01H 1/10

(52) U.S. Cl. 200/512

(57) ABSTRACT

An actuator body or actuator system (1) for electrical and electronic microdevices comprises at least two switch contacts (5, 7) which by way of a membrane (13) extending across at least one of said contacts can be mutually connected when the membrane is depressed for triggering a switching operation. In the actuating system described at least one of the contacts (5) is positioned in the area of the membrane perimeter and is connected via an electroconductive polymer (17) to a conductor strip (15) located on the inside surface of the membrane facing said contacts. The membrane with its conductor strip is suspended above the other contact (7) in such fashion that it and the conductor strip remain at a distance from that other contact when the system is not being operated. When depressed, the membrane can be deflected to said other contact so as to cause the conductor strip to touch that other contact, establishing the electrical connection between the two contacts (5, 7).

This invention relates to an actuator system as conceptually specified in claim 1, designed in particular for electrical and electronic microdevices, to the use of said actuator system and to a hearing aid employing said actuator system.

Electronic microdevices such as hearing aids are equipped with so-called toggle switches and other types of switches for selecting between different programs, for volume adjustment or for simply switching the unit on or off.

In a toggle switch the contacts are usually covered by a flexible membrane such as a molded silicone plate coated with a special, electrically conductive layer. The silicone membrane serves the dual purpose of sealing the housing against extraneous moisture and of triggering the switching operations. The technology involved resembles that employed in those very simple rubber-based or silicone touch-sensitive keypads for instance of cheap pocket calculators. Its particular advantage lies in the simplicity of its implementation and use. The only innovative feature is the conductive layer provided on the silicone membrane.

In using devices equipped with a so-called “toggle membrane” a variety of problems are encountered. One such problem is the less than hermetic sealing of the contacts against extraneous moisture or fluids so that, depending on the degree of impurities in the fluid, the result may be creepage between the contacts. That in turn leads to augmented leakage currents and thus to a shortened battery life, but also to uncontrolled switching operations. Another problem of the technology referred to lies in the fact that the silicone employed is not resistant over the long term to all fluids encountered in the use of electronic microdevices such as hearing aids. Once a fluid has penetrated the membrane, for instance through a capillary effect, the silicone is likely to expand. Various observations made in connection with devices employing these so-called toggle membranes have shown that the problem is typically caused by sun-screen or skin lotions that are transferred to the switches when these are operated by the wearer of the electronic microdevice. When the silicone or the conductive layer on it expands, the result will be breaks in that conductive layer, diminishing or indeed eliminating its conductive properties. In that case, dependable switching is no longer ensured.

It is therefore the objective of this invention to introduce a switch or potentiometer in an actuator system in which the contacts are protected from extraneous moisture and other fluids and from contamination, and in which these contacts permit switching operations in extremely simple fashion.

According to the invention this objective is achieved with an actuator system as described in claim 1.

The proposed system consists of an actuator or switch for electrical or electronic microdevices, encompassing at least two switching contacts which can be connected for triggering a switching operation by applying pressure on the membrane that extends over at least one of the contacts.

At least one of the contacts is positioned in an area near the perimeter of the membrane and connected to the latter via an electrically conductive polymer with a conductor strip, while the membrane extends across the other contact in such fashion that, when the actuator i.e. the membrane is in the idle state, a gap exists between the membrane i.e. its conductor strip and the other contact. When pressure is applied on the membrane, the latter can be deflected in a manner whereby the conductor strip touches the other contact.

The membrane extending across the other contact is preferably resilient and so mounted that, when not depressed, the membrane i.e. the conductor strip will remain at a distance from that other contact.

The electrically conductive polymer is preferably in the form of an anisotropically conductive adhesive, such conductivity preferably being derived from the use of a corresponding filler in the polymer.

For solving the problem mentioned further above, prior art has proposed a variety of approaches, described for instance in U.S. Pat. Nos. 4,375,018, 6,417,467, 5,463,692 and 5,990,425 as well as in the international applications 95/12207, WO 01/67843, in the European patent application EP 0 311 233 and in the German disclosure document DE 43 31 382. All of the proposed approaches are aimed at producing switches i.e. circuit elements that are sealed from the outside as hermetically as possible so as to overcome the problem, explained above, of moisture and fluids entering the system. However, none of the approaches disclosed in the documents listed above provides a solution identical to that per this present invention. It is the use of an electrically conductive adhesive that makes it possible to arrive at a switch, a circuit or a potentiometer which, compared to prior art, is substantially less complicated in design and is significantly easier to produce.

In a design variation of the system according to the invention, the membrane with the switch housing covered by it is sealed on all sides against factors such as extraneous moisture by means of a suitable polymer material, for instance the electrically conductive adhesive mentioned.

Another implementation variant incorporates several switching contacts that can be switched i.e. actuated by applying pressure on the membrane.

The characterizing features of other preferred design variations of the actuator system according to the invention are described in the subordinated claims.

The proposed switch or actuator system according to the invention lends itself particularly well to electronic or electrical microdevices especially including hearing aids.

The following explains the invention in more detail with reference to an implementation example and to the attached drawings in which—

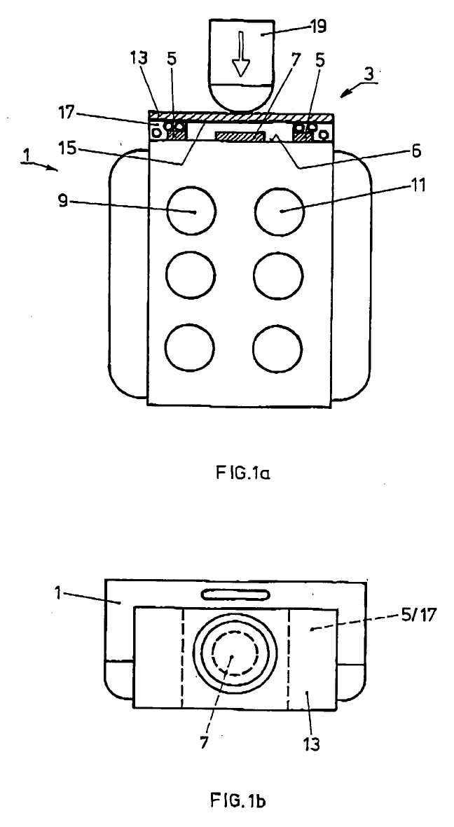

FIG. 1a and 1b are a cross-section and, respectively, top view of an actuator system according to the invention;

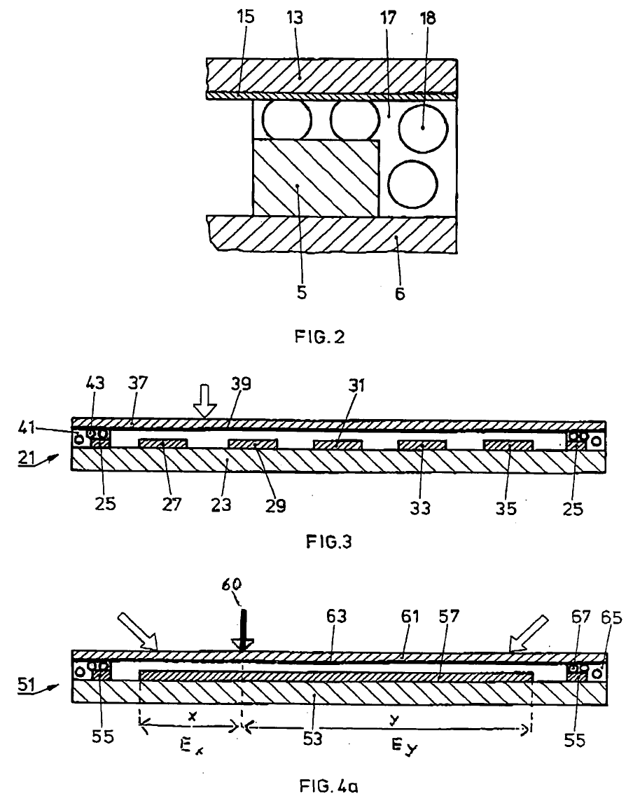

FIG. 2 is an enlarged view of part of the system per FIG. 1;

FIG. 3 is a longitudinal section view of another design variation of an actuator system per this invention;

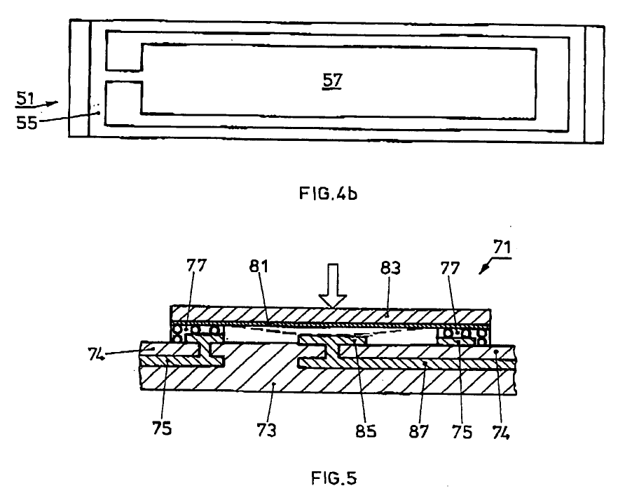

FIGS. 4a and 4b are a longitudinal-section and, respectively, top view of another design version of the actuator system per this invention; and

FIG. 5 shows another implementation variant of a switch according to the invention.

FIGS. 1a and 1b show a so-called toggle switch for actuating switching contacts in an electronic microdevice 1 with connectors 9 and 11, said switch lending itself well to integration for instance in a hearing aid. A lateral section 6 of the switch housing accommodates the switch contacts 5 as well as a centrally located switch contact 7, these being the contacts that are to be connected with one another for triggering a switching operation. Extending across and covering the switch contacts 5 and 7 is a membrane, a so-called “cover layer” 13 whose bottom surface facing the contacts is provided with a conductor strip 15. For establishing a connection between the contacts 5 and the conductor strip 15 the cover layer 13 connects to an electroconductive polymer 17. That may be an electrically conductive adhesive of the type essentially well known in the electronics industry. Electrically conductive adhesives include for instance electroconductive epoxies, polyurethane resins, silicone resins, polyester resins etc., in which case the polymer concerned is mixed with electrically conductive fillers such as metallic filler substances, graphite, carbon black and the like. A suitable material for the cover layer would include flexible, limited-elasticity polymers such as polyamide.

The switch 3 can be actuated for instance with a so-called toggle pin 19 by means of which the membrane, i.e. the cover layer 13, is pushed against the center contact 7 far enough to cause the conductor strip 15 to touch the contact 7.

FIG. 1b is a top view of the switch housing 1 and the cover layer 13. If the membrane i.e. cover layer 13 is transparent, the center electrode 7 will be visible. On its sides the cover layer is hermetically sealed relative to the switch housing 1 by means of the aforementioned electroconductive adhesive.

With regard to the contacts, or electrodes, is should also be pointed out that they may be stratified in special ways for optimal conductance characteristics. For example, relay contacts are preferably gold-plated, while for other applications metals such as nickel etc. can be used, or perhaps special corrosion-resistant alloys.

FIG. 2 is an enlarged view of part of the system per FIG. 1, here clearly showing the lateral electrode 5 that is located on the lateral surface 6 and connects via the electroconductive adhesive 17 to the conductor strip 15 of the cover layer 13. For the purpose of a schematic illustration the electroconductive fillers are represented by spheres 18.

The problem described further above is solved, and the objective of this invention is achieved, by the hermetic sealing of the switching contacts against the intrusion of moisture by means of the electroconductive adhesive or cement and the cover layer. The hermetically sealed switch illustrated in FIGS. 1a, 1b and 2, based on the concept of a so-called flexprint, offers the following advantages:

For the cover layer 13 a material of essentially any type and thickness can be chosen. It is possible, of course, to use in lieu of the suggested polyamide some other suitable polymer, ceramic, glass or metal that has the necessary electrical, mechanical and chemical properties. These materials are commercially available from existing flexprint suppliers.

Applying an anisotropic adhesive as illustrated in the enlarged FIG. 2 is a simple and reliable process. Electroconductive polymers and the anisotropic adhesives mentioned can even be purchased in ready-made form which greatly simplifies the application. Adhesives of that type, including in particular reactive binary cement, can be activated for instance by light, UV or infrared irradiation which minimizes any thermal exposure.

FIG. 3 is a section view of another design variation of a switch 21 according to the invention, in this case serving for instance as a positionally responsive, pressure-sensitive switch or sensor. Here as well, by way of an electroconductive adhesive 41 containing electrically conductive fillers 43, the electrodes 25 located at the perimeter connect to a cover layer 37 the bottom surface of which features a conductor strip 39. The substrate 23 supports several electrodes 27 to 35. With this positionally responsive, pressure-sensitive switch as shown in FIG. 3 it is possible to trigger a specific signal as a function of the location and actuation pressure applied. In the case for instance of a hearing aid that signal may serve to select a program or to adjust the volume. Depending on the pressure applied a smaller or larger number of the electrodes are contacted. It is further possible, by selecting the appropriate material for the cover layer, to define the amount of pressure by means of which only one electrode, or simultaneously several electrodes, is/are touched by the conductor strip. Moreover, limiting the connection to only one electrode can be accomplished by appropriately shifting the point at which the pressure is applied.

The switch illustrated in FIG. 3 may also be constructed along the “clicker” principle. Alternatively, the switch per FIG. 3 could employ a partly flexible housing or, mounted on a flexible substrate 23, it could be designed as a so-called “magic switch”.

FIGS. 4a and 4b show yet another design variation of the switch 51 per this invention in which, again, laterally positioned electrodes 55 connect via an adhesive 65 containing electroconductive fillers 67 to the cover layer 61 the bottom surface of which supports the conductor strip 63. The design per FIG. 4 features one single long, centered electrode 57 that may be contacted for instance in “clicker” fashion. FIG. 4a shows that switch in a longitudinal-section presentation, FIG. 4b is a top view of that switch, with the cover layer removed. The “clicker” concept utilizes the differences in the geometric lengths of the individual strata. In this case the substrate 53 would have to be of a somewhat thicker material than the switch electrode 57. Depending on the design of the switch electrode 57, it would also be possible to configure the switch per FIG. 4 with a keypad-type touch-sensitive membrane whereby the point at which pressure is applied on the pad determines the amount of current allowed to flow through the switch in the actuation process. In that case the point of actuation 60 can be differentially measured based on the correlation of x:y E≅Eₓ:E_{y} as schematically indicated in FIG. 4a.

FIG. 5 is a schematic section view of another design version of a switch according to the invention. The switch 71, positioned on a substrate 73, again encompasses at each end electroconductive strips and electrodes 75 sealed against the outside by an insulating layer 74. Here as well, the electrodes 75 connect via an electroconductive adhesive 77 to a so-called cover layer 83 whose bottom surface features a conductor strip 81. When the cover layer 83 is depressed, the conductor strip 81 is pushed against the electrode 85 in the center of the switch 71, establishing contact between the outer electrodes 75 and the center electrode 85, thus permitting a signal that has been generated to be forwarded via the conductor 87 after that has made contact with the center electrode. In the switch per FIG. 5 as well, all conductors are hermetically sealed for instance against any penetration of extraneous moisture or fluids.

Switches according to the examples shown in FIG. 1 to 5 can positively solve or eliminate the problems inherent in today's so-called toggle switches. This is particularly important for hearing aids in which the use of those toggle switches has led to the common problems described above.

As a matter of course, it is possible to use design variations per this invention for devices other than hearing aids and other than the switches described with reference to FIG. 1 to 5, or to use other types of switches or controllers in conjunction with the actuator systems described. In all and any cases where moisture, chemical substances, perspiration, sun-screen lotions etc. can affect the operation of switches, the actuation systems according to the invention offer a dependable solution to the problem. It follows that even under unfavorable conditions, microdevices can be equipped with suitable switches for proper and reliable operation. In the production of such microdevices this invention introduces a considerable cost reduction in parallel with improved dependability, permitting the use of essentially well-known materials and components. Similarly, these electronic microdevices require significantly less maintenance.

1. Actuator system (1, 21, 51, 71) for electrical and electronic microdevices, comprising at least two switch contacts (5, 7; 25, 27; 55, 57; 75, 83) which by way of a membrane (13, 37, 61, 81) extending across at least one of said contacts can be mutually connected when the membrane is depressed for triggering a switching operation, characterized in that one of the contacts (5, 25, 55, 75) is positioned in the area of the membrane perimeter and is connected via an electroconductive polymer (17, 41, 65, 77) to a conductor strip (15, 39, 63, 83) located on the inside surface of the membrane facing said contacts, that the membrane is suspended above the other contact (7, 27, 57, 85) in such fashion that it and the conductor strip remain at a distance from that other contact when the system is not being operated, and that, when depressed, the membrane can be deflected to said other contact so as to cause the conductor strip to touch that other contact.

2. System as in claim 1, characterized in that the membrane consists of an at least partially elastic, resilient polymer such as polyamide or a similarly suitable other material.

3. System as in claim 1 or 2, characterized in that the electroconductive polymer is an anisotropic adhesive such as a polymer containing electroconductive fillers.

4. System as in one of the claims 1 to 3, characterized in that the electroconductive polymer is a reactive polymer such as an epoxide, polyurethane, silicone or polyester resin etc. containing an electroconductive filler such as a metallic filler, a carbon-like material, carbon black, polymer spheres coated with an electroconductive material such as nickel or silver, etc.

5. System as in one of the claims 1 to 4, characterized in that for controlling or optimizing its/their conductance the contact(s) is/are provided with a special layered structure, for example a cover layer consisting of gold, nickel or some other suitable metal or a metal alloy serving in particular to prevent corrosion.

6. System as in one of the claims 1 to 5, characterized in that on its sides the membrane or cover layer is completely and hermetically sealed relative to a substrate that supports the switch contacts.

7. System as in one of the claims 1 to 6, characterized in that in addition to the contact(s) conductively connected to the membrane at least two or more switch contacts are provided, permitting activation by a movement of the membrane for instance under pressure.

8. System as in one of the claims 1 to 7, characterized in that the contacts are mounted on an at least partially flexible base or flexible substrate and that, along the concept of a so-called “magic switch”, the switch can be actuated by a partial flexure of the substrate and simultaneous movement of the membrane against the contacts across which it is suspended.

9. System as in one of the claims 1 to 8, characterized in that the switch can be operated in “clicker” fashion.

10. System as in one of the claims 1 to 9, characterized in that the said other contact underneath the membrane is elongated and can be activated along the concept of a pressure-sensitive keypad.

11. Use of the system per one of the claims 1 to 10, for triggering one or several switching operations in an electronic or electrical microdevice.

12. Hearing aid equipped with a system per one of the claims 1 to 10, characterized in that said system can switch the hearing aid on and off, that it permits program selection and/or that it can be used for volume control.
